(19) United States
(12) Patent Application Publication
(10) Pub. No.: US 2025/0374907 A1
(43) Pub. Date: Dec. 11, 2025

(54) FLYING INSECT TRAP WITH PHOTOLUMINESCENT GLUE BOARD

(71) Applicant: AP&G Co., Inc., Bayonne, NJ (US)

(72) Inventor: Edward William Dolshun, Warwick, NY (US)

(21) Appl. No.: 19/235,505

(22) Filed: Jun. 11, 2025

Related U.S. Application Data
(60) Provisional application No. 63/658,840, filed on Jun. 11, 2024.

(51) Int. Cl. A01M 1/14; A01M 1/10

(52) U.S. Cl. CPC A01M 1/145; A01M 1/106

(57) ABSTRACT

A photoluminescent glue board for attracting and trapping flying insects. The photoluminescent glue board includes an adhesive layer and photoluminescent pigment incorporated therein or applied thereto. When activated by a light source, the photoluminescent pigment causes the glue board to emit visible light, creating a dual-function element that serves as both attractant and trap. A light trap unit is also provided with inward facing light to illuminate and activate the photoluminescent pigment.

### RELATED APPLICATIONS

This application claims the benefit of pending U.S. Prov. Appl. No. 63/658,840, filed Jun. 11, 2024, the contents of which are incorporated by reference herein.

### FIELD OF THE DISCLOSURE

The present disclosure relates to exemplary embodiments of a fly trap, and more particularly, to exemplary embodiments of an illuminated fly trap having a glue board that glows when exposed to light.

### BACKGROUND OF THE INVENTION

Flying insect traps that employ light to attract flying insects are well known in the art. Conventional light-based insect traps typically utilize ultraviolet (UV) lights, LED arrays, or incandescent bulbs as attractants, with separate elimination mechanisms such as electric grids, adhesive surfaces, or collection chambers positioned near the light source.

However, existing traps suffer from several drawbacks. Many LED or similar light sources lack sufficient intensity to adequately attract insects from meaningful distances. Additionally, because the light source is physically separate from the elimination device (e.g., electric current or glue board), insects may fly toward the light, contact or bounce off the bulb or housing, and escape without contacting the trapping mechanism. This separation between attractant and trap reduces overall effectiveness.

Furthermore, conventional traps often require continuous electrical power to maintain illumination, limiting their portability and increasing operating costs. There exists a need for an improved flying insect trap that integrates the attractant and trapping functions while providing enhanced effectiveness and operational flexibility.

### SUMMARY OF THE INVENTION

Embodiments of the invention provide a flying insect trap system wherein a glue board contains photoluminescent pigment that, when activated by a light source, glows to attract insect. This creates a dual-function element that serves as both attractant and trap.

In one embodiment, a flying insect trap comprises a housing having at least one window, a glue board positioned within the housing and visible through the window, and a light source configured to illuminate the glue board. The glue board includes an adhesive layer and photoluminescent pigment incorporated therein or applied thereto, wherein the photoluminescent emits visible light to attract flying insects to the adhesive surface.

The photoluminescent pigment may comprise one or more of zinc sulfide-based compounds, strontium aluminate-based compounds, calcium sulfide-based compounds, or organic photoluminescent materials in different embodiments of the invention. The pigment may be incorporated directly into the adhesive material, applied as a coating over the adhesive, or incorporated into a substrate underlying the adhesive.

### BRIEF DESCRIPTION OF THE DRAWINGS

Exemplary embodiments of the present disclosure will be described with references to the accompanying figures wherein:

FIG. 1 is a top perspective view of the fly trap, according to an exemplary embodiment of the invention.

FIG. 2 is a top perspective view of the fly trap of FIG. 1 shown in an open position, according to an exemplary embodiment of the invention.

FIG. 3 is a top perspective broken away view of the fly trap of FIG. 1 shown with a light strip removed, in accordance with an embodiment of the invention.

FIG. 4 is a partial side cross-sectional view of a section of a fly trap, in accordance with an embodiment of the invention.

FIG. 5 is a top perspective view of a glue board, in accordance with an embodiment of the invention.

### DETAILED DESCRIPTION OF THE INVENTION

The exemplary embodiments of the present disclosure provide for an illuminated fly trap. Exemplary embodiments of the various methods and apparatuses will now be described with reference to the figures. The following description of the various embodiments is merely exemplary in nature and is in now way intended to limit the scope of the disclosure, its application, or uses.

Embodiments of the invention provide a glue board that is configured to glow when activated by light. Glue boards known in the art comprise a substrate (e.g. paper or cardboard), an adhesive glue layer, and a release liner applied atop the adhesive layer. Glue boards in accordance with embodiments of the invention include photoluminescent pigment integrated therewith.

In exemplary embodiments of the invention, any of various fluorescent pigments or dyes are incorporated into an adhesive layer of a glue board. Such fluorescent pigments may include coumarin or rhodamine-based dyes. In other embodiments fluorescent organic pigments are incorporated.

It will be understood that in other embodiments of the invention photoluminescent pigment incorporated into glue boards of embodiments of the invention provide an “after glow” such that they continue to glow even after the removal of a light source. For example, in embodiments of the invention, materials such as strontium aluminate-based phosphor or zinc sulfide are added to the adhesive layer.

It will be understood that photoluminescent material may comprise any compound or composition capable of absorbing electromagnetic radiation and subsequently emitting visible light, including but not limited to phosphorescent materials, fluorescent materials, persistent luminescent materials, quantum dots, rare earth doped materials, and hybrid organic-inorganic luminescent compounds.

In embodiments of the invention, photoluminescent pigment may be incorporated into a glue board in accordance with any of various methods. In one embodiment, photoluminescent pigment is directly mixed into the adhesive material during manufacture. The mixture is thoroughly blended using mechanical stirers, high-shear mixers, or roller mills to ensure uniform distribution and then applied to a substrate such as card or similar carrier.

In other embodiments of the invention, a base adhesive layer is first applied to a substrate followed by application of photoluminescent pigment as a surface coating. The pigment may be applied as a dry powder using coating or dusting techniques. Alternatively, the pigment may be suspended in a carrier medium (water, alcohol, or organic solvent) and applied by spraying, brushing, or dipping methods.

In another embodiment, a first adhesive sub-layer containing photoluminescent pigment is applied to substrate, followed by a second clear or lightly pigmented adhesive sub-layer that maintains trapping effectiveness while allowing light transmission to and from the underlying photoluminescent layer.

In alternative embodiments of the invention, Photoluminescent pigment is incorporated into a thin film or sheet that is subsequently laminated to the adhesive layer. The film may comprise polymer materials such as polyethylene, polypropylene, or polyester containing distributed pigment particles.

Embodiments of the invention provide a flying insect trap configured to receive a glue board that is capable of glowing when a light source is directed at it. In this regard, the light source (the glowing glue board) is itself an elimination device. In addition, the source of illumination may be stronger and include a greater surface area than that of an LED or similar light source.

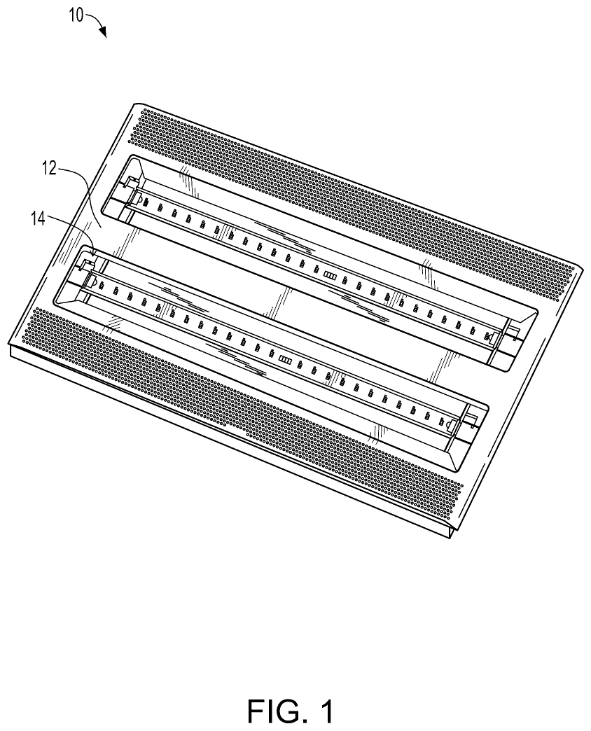

FIG. 1 shows a top perspective view of a flying insect trap 10. In embodiments of the invention, and as shown, insect trap 10 is formed of a cabinet having a front plate 12 that is provided with windows 14 configured to allow ingress of flying insects.

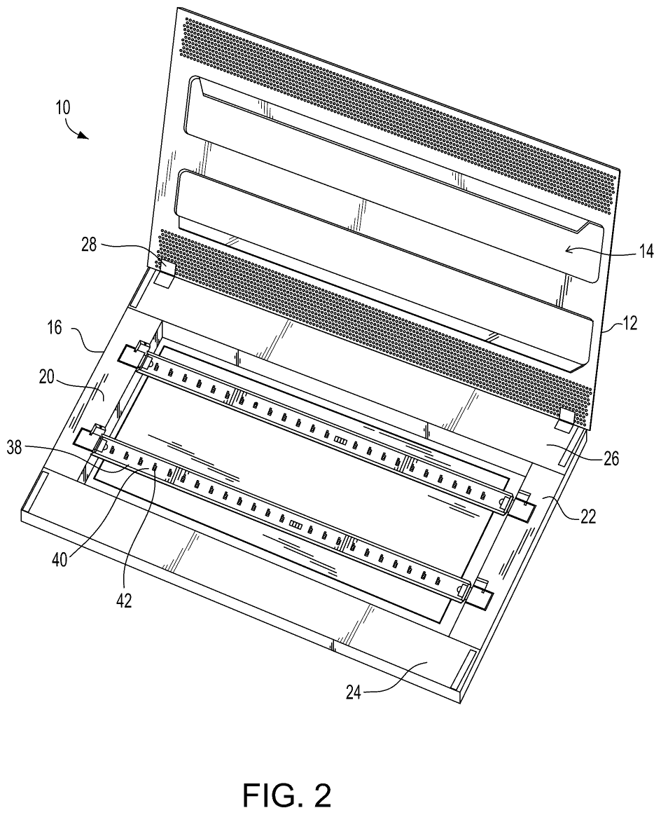

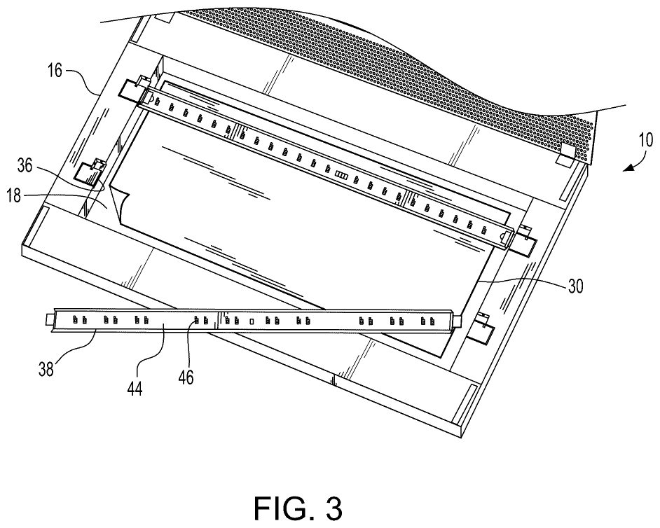

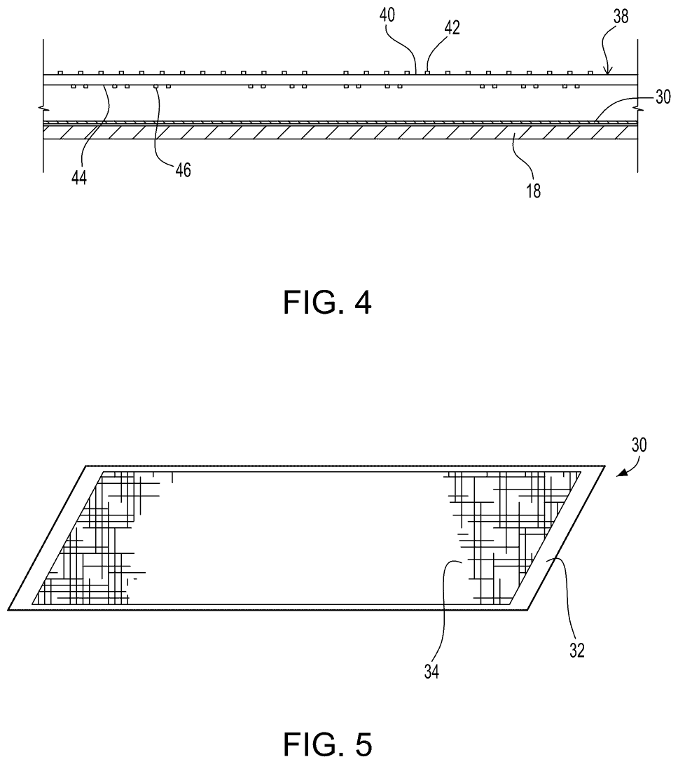

With reference to FIG. 2, in embodiments of the invention front plate 12 is hingedly connected to base 16 of insect trap 10 via one or more hinges (e.g. 28). Base 16 includes a recessed floor surface 18 (best shown in FIG. 3) surrounded by left and right ledges 20, 22 and lower and upper ledges 24, 26. One or more hinges (e.g. 28) attach cover plage 12 to upper ledge 26 of base 16. As shown, floor surface 18 is sized and shaped to receive a glue board 30. Glue board 30 is placed such that an underside substrate material 32 rests on floor surface 18 and the adhesive layer faces windows an underside of face plate 12.

As shown in FIG. 2 and FIG. 3, one more light strips (e.g. 38) are provided to transmit visible light. As shown, light strip 38 is an elongated member having a top surface 40 that carries one more light emitting devices, such as LEDs (e.g. 42). Each end of light strip 38 is configured to connect to a socket (e.g. 36 as shown in FIG. 3) for electronic connection. LEDs 42 project light out of windows 14 to attract flying insects.

Referring to FIG. 3, which shows an underside surface 44 of light strip 38, in embodiments of the invention, one or more LEDs 46 are provided to project downwardly at the glue board 30. In this regard, in embodiments of the invention, when light strip 38 is installed with underside 44 facing downward (toward the floor surface 18) LEDs (e.g. 46) activate the photoluminescent pigment contained on the glue board 30—thereby causing the glue board 30 to glow. Accordingly, in embodiments of the invention, all or a substantial portion of the adhesive surface 34 of glue board 30 glows in the dark and serves as an attractant to flying insects. Because the light-emitting element (the glowing glue board) is itself a trap—the trapping surface in accordance with an embodiment of the invention is more effective in trapping more insects than known traps.

It should be understood that a light source to activate the glue board may include any of various devices capable of emitting electromagnetic radiation suitable for activating photoluminescent materials, including but not limited to light emitting diodes (LEDs), laser diodes, organic light emitting diodes (OLEDs), electroluminescent panels, incandescent bulbs, fluorescent tubes, plasma discharge devices, or any combination thereof.

It will be understood that in embodiment of the invention, a light source configured to activate a glue board may be positioned at any of various orientations. In this regard, the light source may be positioned at any angle relative to a plane of the glue board, including but not limited to positions laterally adjacent to, diagonally oriented from, or overhead of the glue board.

In preferred embodiments, the light sources emit wavelengths in the range of 300-700 nanometers, with particular effectiveness in the UV-A range (315-400 nm) and blue light range (400-500 nm) for photoluminescent activation.

In operation, light sources (e.g. LED 46) activate photoluminescent pigment contained in glue board 30 during a time that light is projected onto the glue board 20. In embodiments of the invention whereby pigment with afterglow properties is used, the pigment absorbs energy from the incident light and subsequently emits visible light over an extended period, typically ranging from 30 minutes to 12 hours depending on the pigment type and activation intensity. This emission creates a glowing surface that attracts flying insects directly to the adhesive trap.

The invention includes a method of forming a glue board by providing adhesive material and photoluminescent pigment on a backing sheet. The method further includes installing the glue board in a trap such that the glue board is visible from outside the trap. A light source configured to direct light at the glue board is activated to shine light at the glue board (in the substantial opposite direction of target insects), and thereby activate photoluminescent pigment contained in the glue board 30.

The invention further includes a method of manufacturing the photoluminescent glue board including the steps of providing a substrate; preparing an adhesive composition by mixing base adhesive material with photoluminescent pigment in predetermined ratios; applying the pigmented adhesive composition to the substrate using coating techniques such as knife coating, gravure coating, or extrusion coating; curing or drying the adhesive layer; and optionally applying protective release papers or films.

The present invention provides numerous advantages over conventional flying insect traps. The integration of attractant and trap functions eliminates inefficiencies inherent to separated attracting and catching devices—and improves capture rates. In embodiments of the invention, extended afterglow periods reduce energy consumption compared to continuously powered systems. The trap remains effective during power outages or in locations without electrical access after initial activation.

The foregoing merely illustrates the principles of the disclosure. Various modifications and alterations to the described embodiments will be apparent to those skilled in the art in view of the teachings herein. It will this be appreciated that those skilled in the art will be able to devise numerous systems, arrangements, manufacture and methods which, although not explicitly shown or described herein, embody the principles of the disclosure and are thus within the spirit and scope of disclosure.

What is claimed is:

1. A flying insect trap comprising:
a housing having at least one window configured to allow ingress of flying insects;
a glue board positioned within the housing and visible through the window, the glue board comprising:
a substrate;
an adhesive layer applied to the substrate; and
fluorescent photoluminescent pigment incorporated within the adhesive layer; and
a light source positioned to illuminate the glue board and configured to emit light that activates the fluorescent photoluminescent pigment to cause the glue board to emit visible light substantially simultaneously with illumination by the light source, thereby attracting flying insects to the adhesive layer.

2. The flying insect trap of claim 1, wherein the fluorescent photoluminescent pigment comprises fluorescent organic pigments.

3. The flying insect trap of claim 1, wherein the fluorescent photoluminescent pigment is directly mixed into the adhesive layer.

4. The flying insect trap of claim 1, wherein the light source comprises a plurality of light emitting diodes (LEDs).

5. The flying insect trap of claim 4, wherein the plurality of light emitting diodes (LEDs) are provided on a lighting strip having an upper surface and an underside surface, and whereby one or more of the plurality of light emitting diodes (LEDs) are provided on the upper surface of the lighting strip and one or more of the plurality of light emitting diodes (LEDs) are provided on the underside surface of the lighting strip.

6. The flying insect trap of claim 4, whereby the plurality of light emitting diodes (LEDs) are configured to emit light in a wavelength range of 300-700 nanometers.

7. The flying insect trap of claim 6, wherein one or more of the plurality of light emitting diodes (LEDs) provided on the underside surface of the lighting strip are configured to direct light downwardly toward the glue board and cause luminescence of the glue board.
